(19) United States
(12) Patent Application Publication
(10) Pub. No.: US 2022/0410903 A1
(43) Pub. Date: Dec. 29, 2022

(54) VEHICLE CONTROL DEVICE

(71) Applicant: TOYOTA JIDOSHA KABUSHIKI KAISHA, Toyota-shi (JP)

(72) Inventors: Atsushi KAMADA, Miyoshi-shi (JP); Masato TATENO, Toyota-shi (JP); Kazuhiro OZAWA, Toyota-shi (JP)

(73) Assignee: TOYOTA JIDOSHA KABUSHIKI KAISHA, Toyota-shi (JP)

(21) Appl. No.: 17/703,373

(22) Filed: Mar. 24, 2022

(30) Foreign Application Priority Data
Jun. 24, 2021 (JP) 2021-105250

(51) Int. Cl. B60W 30/19; F16D 48/06; B60W 10/06; B60W 10/02; B60W 10/10

(52) U.S. Cl. CPC B60W 30/19; F16D 48/06; B60W 10/06; B60W 10/02; B60W 10/10; F16D 2500/10412; F16D 2500/1085; F16H 2061/283

(57) ABSTRACT

In a vehicle equipped with an engine and a shift control mechanism that switches a shift position by rotating a detent plate with an electric actuator, an electronic control device is an electronic control device including a reference position learning unit that executes a learning of a reference position of the actuator that serves as a reference for switching the shift control mechanism by the actuator when a starting condition that is set in advance is satisfied, and includes a drive wheel rotation suppression unit that suppresses a rotation of a drive wheel of the vehicle while the learning of the reference position is being executed by the reference position learning unit.

### CROSS-REFERENCE TO RELATED APPLICATION

This application claims priority to Japanese Patent Application No. 2021-105250 filed on Jun. 24, 2021, incorporated herein by reference in its entirety.

### BACKGROUND

### 1. Technical Field

The present disclosure relates to a vehicle control device provided with a mechanism for switching a shift range using an electric actuator.

### 2. Description of Related Art

A vehicle control device including a shift control system that converts a shift operation by a driver into an electric signal and drives an electric actuator based on the electric signal to switch a shift range of a drive device is known. A control device described in Japanese Unexamined Patent Application Publication No. 2017-219166 (JP 2017-219166 A) is the vehicle control device described above. JP 2017-219166 A describes that the vehicle control device includes a reference position learning unit that rotates the actuator and learns a P position that is a reference position of the actuator based on a R position or a D position that is a non-P position of a detent plate, as a P wall position detection control, when the vehicle power switch is turned on and the shift control system is activated.

### SUMMARY

In the reference position learning unit that executes the learning of the P position in the vehicle control device described above, there is a concern that a power transfer path of the R range or the D range is temporarily formed when the R position or the D position that is the non-P position of the detent plate is passed, and while the engine is running, generation of the driving force of the vehicle that is not intended by the driver occurs.

The present disclosure has been made in the background of the above circumstances, and an object of the present disclosure is to provide a vehicle control device without any concern that the driving force of the vehicle is unintentionally generated while control to learn the reference position is being executed by the reference position learning unit.

The gist of the first disclosure is (a) a vehicle control device provided with, in a vehicle equipped with an engine and a shift control mechanism that switches a shift position by rotating a detent plate by an electric actuator, a reference position learning unit that executes a learning of a reference position of the actuator that serves as a reference for switching the shift control mechanism by the actuator when a starting condition that is set in advance is satisfied, and (b) the vehicle control device including a drive wheel rotation suppression unit that suppresses a rotation of a drive wheel of the vehicle while the learning of the reference position is being executed by the reference position learning unit.

The gist of the second disclosure is that, in the vehicle control device of the first disclosure, the drive wheel rotation suppression unit prohibits starting of the engine while the learning of the reference position is being executed by the reference position learning unit.

The gist of the third disclosure is that, in the vehicle control device of the first disclosure, the vehicle is provided with an automatic transmission between the engine and the drive wheel, and the drive wheel rotation suppression unit disengages a friction engagement device in the automatic transmission to disable power transfer while the learning of the reference position is being executed by the reference position learning unit.

The gist of the fourth disclosure is that, in the vehicle control device of the first disclosure, the vehicle is provided with a brake device that stops the rotation of the drive wheel, and the drive wheel rotation suppression unit blocks the rotation of the drive wheel by the brake device while the learning of the reference position is being executed by the reference position learning unit.

With the vehicle control device according to the first disclosure, the drive wheel rotation suppression unit suppresses the rotation of the drive wheels by the drive wheel rotation suppression unit that suppresses the rotation of the drive wheels of the vehicle while the learning of the reference position is being executed by the reference position learning unit. With this process, the drive wheel rotation suppression unit suppresses the rotation of the drive wheels of the vehicle during the control for setting the reference position by the reference position learning unit, whereby the vehicle control device without the concern that the driving force of the vehicle is unintentionally generated can be obtained.

With the vehicle control device according to the second disclosure, the drive wheel rotation suppression unit prohibits starting of the engine while the learning of the reference position is being executed by the reference position learning unit. With this process, the drive wheel rotation suppression unit suppresses the rotation of the drive wheels of the vehicle due to running of the engine during the control for setting the reference position by the reference position learning unit, whereby the vehicle control device without the concern that the driving force of the vehicle is unintentionally generated can be obtained.

With the vehicle control device according to the third disclosure, the drive wheel rotation suppression unit disengages a friction engagement device in the automatic transmission to disable power transfer while the learning of the reference position is being executed by the reference position learning unit. Therefore, the vehicle control device without the concern that the driving force of the vehicle is unintentionally generated can be obtained.

With the vehicle control device according to the fourth disclosure, the vehicle includes a brake device that stops the rotation of the drive wheel, and the drive wheel rotation suppression unit blocks the rotation of the drive wheel by the brake device while the learning of the reference position is being executed by the reference position learning unit. Therefore, the vehicle control device without the concern that the driving force of the vehicle is unintentionally generated can be obtained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle to which the present disclosure is applied;

FIG. 2 is a diagram showing the structure of a shift control mechanism shown in FIG. 1;

FIG. 3 is a diagram showing an enlarged view of a cam surface of a detent plate shown in FIG. 2;

FIG. 4 is a flowchart illustrating a main portion of a control operation in an electronic control device shown in FIG. 1;

FIG. 5 is a flowchart illustrating a main portion of a control operation in the electronic control device according to another embodiment of the present disclosure, and is a diagram corresponding to FIG. 4; and

FIG. 6 is a flowchart illustrating a main portion of a control operation in the electronic control device according to still another embodiment of the present disclosure, and is a diagram corresponding to FIG. 4.

### DETAILED DESCRIPTION OF EMBODIMENTS

Hereinafter, an embodiment of the present disclosure will be described in detail with reference to the drawings. Note that, in the following embodiments, the drawings are appropriately simplified or modified, and the dimensional ratios and shapes of the respective parts are not necessarily drawn accurately.

### First Embodiment

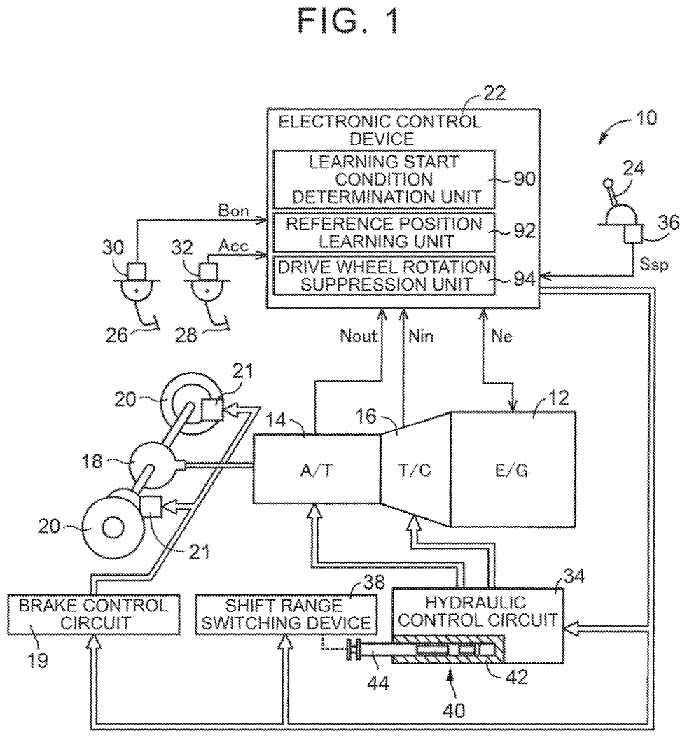

FIG. 1 is a diagram schematically showing a drive device of a vehicle 10 to which the present disclosure is preferably applied and a part of a control system thereof. The drive device of the vehicle 10 includes an engine 12, an automatic transmission 14, a torque converter 16, and the like. A driving force generated by the engine 12 is transferred to the automatic transmission 14 via the torque converter 16. Then, the driving force of which speed is changed by the automatic transmission 14 is transferred to right and left drive wheels 20 via a differential gear device 18. The engine 12 is a driving force source that generates a driving force for traveling the vehicle 10, and is, for example, an internal combustion engine such as a gasoline engine or a diesel engine that generates the driving force through combustion of a fuel injected into a cylinder. Further, a brake device 21 that brakes the corresponding drive wheel 20 using a hydraulic pressure from a brake control circuit 19 is provided.

Further, the vehicle 10 includes an electronic control device 22 for executing various controls related to the vehicle 10. The electronic control device 22 is, for example, a so-called computer provided with a central processing unit (CPU), a random access memory (RAM), a read-only memory (ROM), an input interface, and the like. The electronic control device 22 is configured to execute various controls such as an output control of the engine 12, and moreover, a shift control of the automatic transmission 14 and a shift-by-wire control, in a manner such that the CPU executes a signal processing in accordance with a program stored in advance in the ROM while using a transitory storage function of the RAM. The electronic control device 22 includes an engine control computer E/G-electronic control unit (ECU) that controls a combustion state and an output of the engine 12, a shift control computer ECT-ECU that controls shifting of the automatic transmission 14, a shift-by-wire control computer SBW-ECU that controls a shift range switching device 38 and a parking lock device 46 that will be described later, and a ECB-ECU that controls the brake device 21 via the brake control circuit 19.

As shown in FIG. 1, a signal indicating a detection value from each of various sensors and switches is supplied to the electronic control device 22. That is, a signal indicating an engine speed Ne of the engine 12 from an engine speed sensor (not shown), a signal indicating an input rotation speed Nin of the automatic transmission 14 from an input rotation speed sensor (not shown), that is, an output rotation speed from the torque converter 16, a signal indicating a vehicle speed V corresponding to an output rotation speed Nout of the automatic transmission 14 from a vehicle speed sensor (not shown), a signal indicating whether the accelerator pedal 28 is depressed and an operation amount (depression amount) Acc of the accelerator pedal 28 from an accelerator operation amount sensor 32, a signal Bon indicating the operation of a brake pedal 26 from a brake switch 30, and an operation signal Ssp indicating a shift direction operation position of the shift lever 24, for example, an operation position of any one of a P operation position, a R operation position, a N operation position, and a D operation position from a shift position sensor 36 are supplied to the electronic control device 22, and the electronic control device 22 determines the operation position of the shift lever 24 based on the operation signal Ssp. The operations and operation amounts of the accelerator pedal 28, the brake pedal 26, and the shift lever 24 are supplied as electric signals. This is also referred to as a by-wire method.

The electronic control device 22 outputs the signals for controlling the operations of various devices provided in the vehicle 10. That is, for example, the electronic control device 22 outputs, as engine output control command signals for the output control of the engine 12, a signal for driving a throttle actuator that controls opening and closing of an electronic throttle valve in accordance with the accelerator operation amount (depression amount) Acc, an injection signal for controlling an amount of fuel injected into the engine 12, an ignition timing signal for controlling an ignition timing of the engine 12 by an ignition device, and the like, although not shown.

A hydraulic control circuit 34 selectively switches to one of a plurality of shift stages by controlling a hydraulic pressure to a plurality of clutches and brakes in the torque converter 16 and the automatic transmission 14, that is, hydraulic friction engagement devices, based on the signals from the electronic control device 22. Further, the hydraulic control circuit 34 includes the shift range switching device 38 that switches shift ranges based on the operation signal Ssp of the shift lever 24. The shift range switching device 38 further includes a manual valve 40 of which operational state is switched by the shift range switching device 38.

The manual valve 40 includes a valve body 42 provided with an input port to which a line pressure is input, a forward shift stage output port that supplies the hydraulic pressure to the hydraulic friction engagement device that involves in establishment of the forward shift stage in the automatic transmission 14, a rear shift stage output port that supplies the hydraulic pressure to the hydraulic friction engagement device that involves in establishment of the rear shift stage in the automatic transmission 14, and a discharge port for discharging the hydraulic pressure supplied to each of the hydraulic friction engagement devices. Further, the manual valve 40 includes a spool valve 44 that is inserted into the valve body 42 and moved in an inserting direction, that is, an axial direction such that each of the ports is opened and closed and the ports communicate with each other in accordance with the moving position of the spool valve 44.

The shift lever 24 is disposed near the driver seat, for example, and is configured to be operated manually to any one of a plurality of shift positions provided sequentially, for example, five shift positions of “P”, “R”, “N”, “D”, and “L” positions. The P position is a parking position at which a neutral state in which power transfer from the engine 12 is blocked is established and a mechanical parking mechanism mechanically blocks a rotation of an output shaft (not shown) of the automatic transmission 14. The R position is a rearward traveling position at which the rotation direction of the output shaft is set to be reversed. The N position is a neutral position at which power transfer in the automatic transmission 14 is blocked. The D position is a forward traveling position at which an automatic shifting mode in which the vehicle 10 is traveling forward while the automatic shifting of the automatic transmission 14 is performed is established. The L position is an engine brake position that retains the automatic transmission 14 on a low gear side and generates strong engine brake.

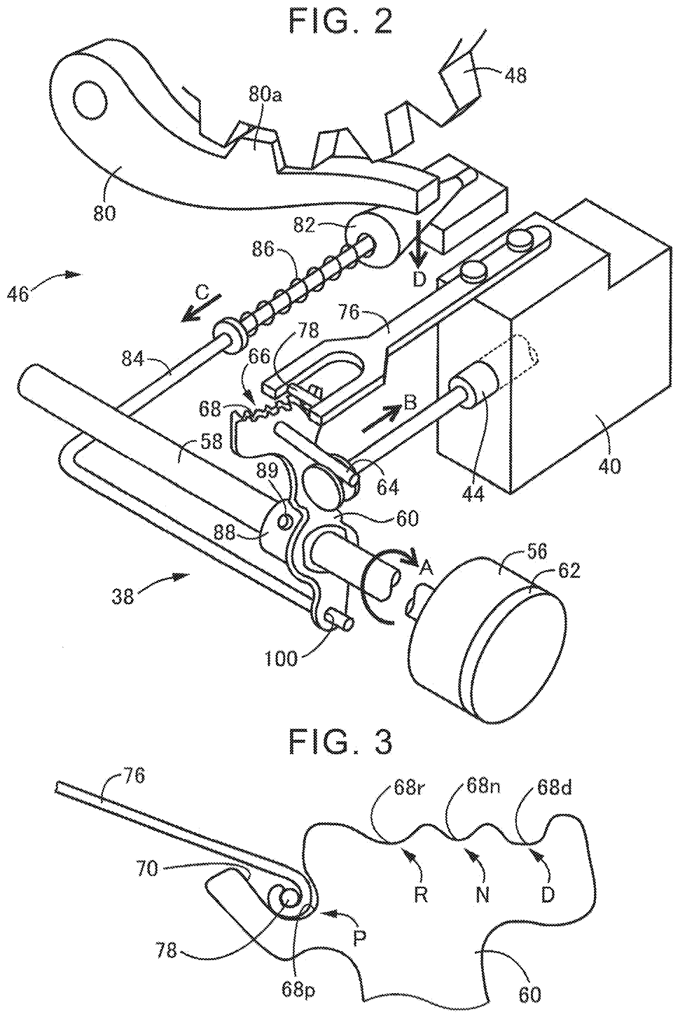

FIG. 2 is a perspective view showing the shift control mechanism that adopts the shift-by-wire method between the shift range switching device 38 that switches the shift range of the automatic transmission 14 and the parking lock device 46 that fixes the output shaft of the automatic transmission 14 so as not to be rotatable. The shift range switching device 38 includes an electric actuator 56 that is operated based on the electric signal (operation signal) Ssp that is output in response to the shifting operation of the shift lever 24 shown in FIG. 1, a manual shaft 58 connected to an output shaft of the actuator 56 via, for example, a speed reduction device, and a plate-shaped detent plate 60 that is fixedly provided to the manual shaft 58, engaged with the spool valve 44 of the manual valve 40, and rotated to one of a plurality of rotating positions corresponding to a plurality of moving positions of the spool valve 44 set in advance in accordance with the shift ranges.

As shown in FIG. 2, the manual shaft 58 and the detent plate 60 are fixed to each other via a boss 88. The manual shaft 58 and the boss 88 are fixed to each other by a fixing pin 89 such that the manual shaft 58 is not rotatable in a circumferential direction of the axial center of the manual shaft 58. Further, the detent plate 60 and the boss 88 are fixed in a manner such that a force is applied to the boss 88 inserted into the detent plate 60 so as to elastically deform the boss 88, that is, crimping the boss 88. The actuator 56 is configured of a step motor such as a switched reluctance motor (SR motor). The operation position of the actuator 56, that is, the rotation angle of a rotor of the actuator 56, is detected by a rotary encoder 62.

The detent plate 60 includes a spool valve engagement rod 64 that is provided to protrude from one side surface of the detent plate 60 toward a thickness direction and engages with the spool valve 44 in an axial direction (moving direction) of the spool valve 44. When the detent plate 60 is rotated around the axial center of the manual shaft 58, the spool valve 44 is moved toward the axial direction of the spool valve 44 by the spool valve engagement rod 64 in accordance with the rotating position of the detent plate 60.

Further, the detent plate 60 is provided with a function of positioning the spool valve 44 at any one of a plurality of moving positions set in advance in accordance with a cam surface shape of an outer peripheral edge portion of the detent plate 60. A cam surface 66 of the outer peripheral edge portion that is positioned in an upper portion of the detent plate 60 is provided with a plurality of cam surface recess portions 68 for positioning the spool valve 44 at a plurality of rotating positions of the detent plate 60 corresponding to the moving positions of the spool valve 44 that are set in advance in accordance with the shift positions of the spool valve 44. An engagement roller 78 abuts the cam surface recess portion 68. The engagement roller 78 is rotatably supported at a tip end portion of a detent spring 76 of which base end portion is fixed.

The detent spring 76 urges the engagement roller 78 toward the cam surface 66 by a predetermined pressing force. With this configuration, basically, the engagement roller 78 is fitted into any one of the cam surface recess portions 68 such that the detent plate 60 is positioned at any one of the rotating positions, and the spool valve 44 is positioned at any one of the moving positions that are set in advance in accordance with the shift positions. FIG. 3 is a diagram showing an enlarged view of the cam surface 66 of the detent plate 60 shown in FIG. 2. The cam surface 66 is provided with, as the cam surface recess portions 68, a D position recess portion 68d, an N position recess portion 68n, an R position recess portion 68r, and a P position recess portion 68p in sequence.

The parking lock device 46 is configured to include: a parking gear 48 connected to an output shaft (not shown) of the automatic transmission 14 shown in FIG. 1; a parking lock pole 80 that is provided with a hook portion 80a that approaches or is away from the parking gear 48 when the parking lock pole 80 is rotated about the axial center and that meshes with the parking gear 48 when the hook portion 80a approaches the parking gear 48, and that fixes the output shaft so as not to be rotatable in a manner such that the hook portion 80a meshes with the parking gear 48; a parking rod 84 that is inserted into a taper member 82 engaging with the parking lock pole 80 and that supports the taper member 82 at one end portion of the parking rod 84; and a spring 86 urging the taper member 82 toward a small diameter side of the taper member 82.

The other end portion of the parking rod 84 is connected to a parking rod hole 100 provided in a lower end portion of the detent plate 60. The taper member 82 is moved toward the small diameter side or toward the large diameter side of the taper member 82 as the detent plate 60 is rotated.

FIG. 2 shows a state in which the detent plate 60 is positioned at the rotating position corresponding to the P range, and the parking lock pole 80 meshes with the parking gear 48. In this state, the spool valve 44 of the manual valve 40 is moved to the moving position corresponding to the P range, and the hydraulic friction engagement device in the automatic transmission 14 is disengaged, whereby power is not transferred. Further, the hook portion 80a of the parking lock pole 80 meshes with the parking gear 48 so as to block the rotation of the output shaft of the automatic transmission 14.

When the manual shaft 58 is rotated toward a direction indicated by the arrow A shown in FIG. 2 from this state using the actuator 56, the spool valve 44 is moved toward a direction indicated by the arrow B and positioned at the moving position corresponding to other shift range. Further, the one end portion of the parking rod 84 is moved toward a direction indicated by the arrow C and the parking lock pole 80 is moved toward a direction indicated by the arrow D as the taper member 82 provided at the one end portion of the parking rod 84 moves. Then, the parking lock pole 80 is moved toward the direction indicated by the arrow D and the hook portion 80a is moved to a position at which the hook portion 80a does not mesh with the parking gear 48, whereby the output shaft is unlocked.

The electronic control device 22 stores the reference position of the actuator 56 that is set in advance through learning, and further stores an encoder count CP (rotation amount) of the rotary encoder 62 from the reference position for each shift range. Therefore, the electronic control device 22 detects the encoder count CP by the rotary encoder 62 as needed, and rotates the manual shaft 58 to the rotation angle corresponding to the P range, or other range of the R range, the N range, or the D range based on the encoder count CP, whereby the position of the manual valve 40 is switched to the position corresponding to the operation position of the shift lever 24.

Hereinafter, learning of the reference position (P position) of the actuator 56 executed by the electronic control device 22 will be described. The electronic control device 22 functionally includes a learning start condition determination unit 90 that determines that a learning start condition for starting learning of the reference position of the actuator 56 is satisfied, a reference position learning unit 92 that learns and sets the reference position of the actuator 56 used for controlling the actuator 56, that is, the P position of the detent plate 60, and a drive wheel rotation suppression unit 94 that suppresses a rotation of the drive wheels 20 of the vehicle 10 while the reference position learning unit 92 is executing the learning.

The learning start condition determination unit 90 determines whether any one of the learning start conditions is satisfied. The leaning start conditions include a condition that the driver operates the shift lever 24 to the N position, a condition that the driver operates a learning start input operation device (not shown), a condition that resupply of the electric power from the power source of the vehicle 10 is started, and the like.

The reference position learning unit 92 executes learning of the reference position of the actuator 56 every time the learning start condition determination unit 90 determines that the learning start condition is satisfied. When the learning start condition determination unit 90 determines that the learning start condition is satisfied, the reference position learning unit 92 rotates the detent plate 60 in a direction opposite to the direction indicated by the arrow A in FIG. 2 until the engagement roller 78 engages with the P position recess portion 68p after the actuator 56 is rotated in the direction indicated by the arrow A in FIG. 2 to a position at which the engagement roller 78 engages the D position recess portion 68d of the detent plate 60. At this time, the engagement roller 78 is made to collide with a P wall 70 constituting the P position recess portion 68p.

When the engagement roller 78 collides with the P wall 70, movement of the engagement roller 78 is restricted. The reference position learning unit 92 rotates the actuator 56 even after the engagement roller 78 collides with the P wall 70. This causes deflection of the detent spring 76. Then, when the rotational force of the actuator 56, the elastic return force due to the deflection of the detent spring 76, and the pushing back force of the parking rod 84 are balanced, the rotation of the detent plate 60 is stopped in a state where the detent spring 76 is deflected.

When the reference position learning unit 92 determines that the rotation of the detent plate 60 (that is, the rotation of the actuator 56) is stopped, the reference position learning unit 92 sets the rotation position of the actuator 56 at that time to the provisional reference position (P position). Then, the reference position learning unit 92 calculates the amount of deflection of the detent spring 76, corrects the provisional reference position based on the calculated amount of deflection, and determines the reference position (learning, P wall learning). The reference position after this correction is a position where the engagement roller 78 and the P wall 70 of the detent plate 60 are in contact with each other and the amount of deflection of the detent spring 76 becomes zero.

The drive wheel rotation suppression unit 94 suppresses the rotation of the drive wheels 20 of the vehicle 10 while the reference position learning unit 92 is executing the reference position learning so as to eliminate a concern of an unintended generation of a driving force of the vehicle 10 caused by that the manual valve 40 is temporarily positioned at the D position and the R position in the process in which the reference position learning unit 92 positions the engagement roller 78 at a position at which the engagement roller 78 engages the D position recess portion 68d of the detent plate 60 and the engagement roller 78 engages with the P position recess portion 68p after that. For example, the drive wheel rotation suppression unit 94 executes at least one of a process of stopping running of the engine 12 so as to suppress the rotation of the drive wheels 20 of the vehicle 10, a process of disabling power transfer by disengaging the friction engagement device in the automatic transmission 14, and a process of stopping the rotation of the drive wheels 20 by the brake devices 21, while the reference position learning unit 92 is executing the reference position learning.

When a command to start the engine 12 is output, the E/G-ECU of the electronic control device 22 drives a starter motor (not shown) mechanically connected to a crankshaft of the engine 12 to rotate the crankshaft. When the rotation speed of the crankshaft rises to the rotation speed at which the engine 12 can operate independently, fuel is injected and the ignition device is operated to start the engine 12.

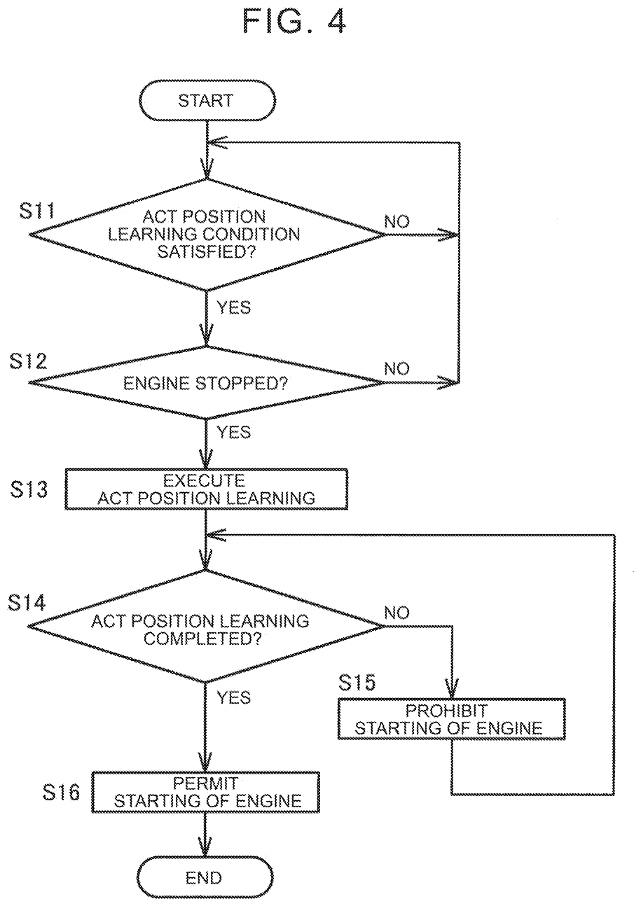

FIG. 4 is a flowchart illustrating a main portion of the control operation of the SBW-ECU of the electronic control device 22. In FIG. 4, in step S11 (hereinafter, step is omitted), the SBW-ECU determines whether the learning start condition of the P position (ACT position) that is the reference position of the actuator 56 is satisfied, for example, whether the driver performs the learning start operation, whether the driver operates the shift lever 24 to the N position, or whether the electric power is supplied from the vehicle power source (not shown). When the determination in S11 is negative, the execution of S11 is repeated to stand by.

When the determination in S11 is affirmative, in S12, the SBW-ECU determines whether the engine 12 is stopped. This is another staring condition for the reference position learning. When the determination in S12 is negative, the execution of S11 is repeated to stand by. However, when the determination in S12 is affirmative, the reference position learning of the actuator 56 is executed in S13 corresponding to the reference position learning unit 92.

Next, in S14, the SBW-ECU determines whether the reference position learning is completed, that is, whether the reference position (P position) of the actuator 56 is determined. When the determination in S14 is negative, the reference position learning is being executed. Therefore, the engine 12 is prohibited from starting in S15 corresponding to the drive wheel rotation suppression unit 94, and the rotation of the drive wheels 20 of the vehicle 10 caused by running of the engine 12 is suppressed while the reference position learning is being executed, whereby unintentional generation of the driving force of the vehicle 10 is avoided. However, when the determination in S14 is affirmative, starting of the engine 12 is permitted in S16.

With the SBW-ECU of the electronic control device 22 that functions as the control device according to the present embodiment, in S15 corresponding to the drive wheel rotation suppression unit 94, starting of the engine 12 is prohibited while the reference position learning is being executed in S13 corresponding to the reference position learning unit 92. With this process, the rotation of the drive wheels 20 of the vehicle 10 due to running of the engine 12 is suppressed during the control for setting the reference position by the reference position learning unit 92, whereby the concern that the driving force of the vehicle 10 is unintentionally generated during the reference position learning of the actuator 56 is eliminated.

Next, another embodiment of the present disclosure will be described. In the following description, the description will be omitted for the portions common to the above-described embodiment.

### Second Embodiment

In a second embodiment, as compared with the first embodiment, there is a difference in that the drive wheel rotation suppression unit 94 disengages the friction engagement device in the automatic transmission 14 to disable power transfer while the reference position learning unit 92 is executing the reference position learning of the actuator 56 so as to eliminate unintentional generation of the driving force of the vehicle 10.

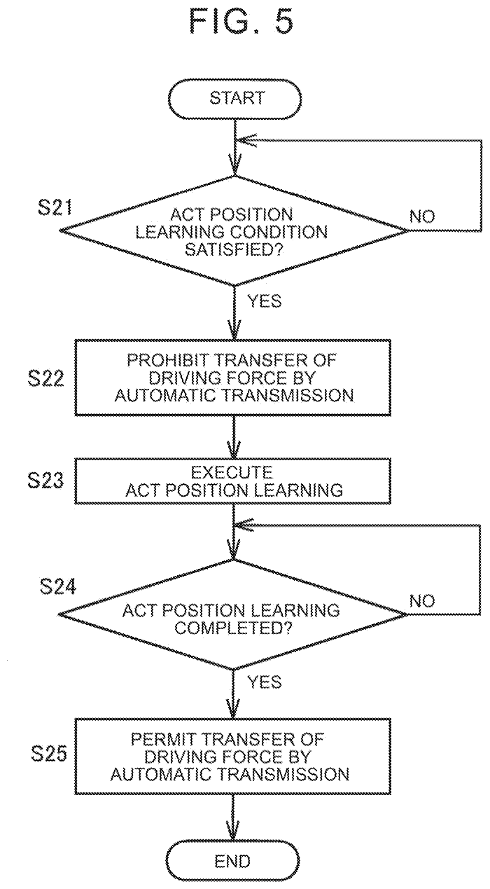

FIG. 5 is a flowchart illustrating a main portion of the control operation of the electronic control device 22 (SBW-ECU) according to the second embodiment. In FIG. 5, in S21, similar to S11, the SBW-ECU determines whether the learning start condition of the P position (ACT position) that is reference position of the actuator 56 is satisfied. When the determination in S21 is negative, the execution of S21 is repeated to stand by.

When the determination of S21 is affirmative, in S22 corresponding to the drive wheel rotation suppression unit 94, an oil pump that supplies the hydraulic pressure to the automatic transmission 14 is stopped, or the ECT-ECU of the electronic control device 22 is caused to output a disengagement command of the hydraulic friction engagement device in the automatic transmission 14. With this process, the hydraulic friction engagement device in the automatic transmission 14 is disengaged, and the power transfer of the automatic transmission 14 is prohibited. Subsequently, in S23 corresponding to the reference position learning unit 92, the reference position learning of the actuator 56 is executed.

Next, in S24, similar to S14, the SBW-ECU determines whether the reference position learning is completed, that is, whether the reference position (P position) of the actuator 56 is determined. When the determination in S24 is negative, the execution of S24 is repeated to stand by.

When the determination in S24 is affirmative, in S25, the power transfer of the automatic transmission 14 is permitted, the oil pump that supplies the hydraulic pressure to the automatic transmission 14 is activated, or the hydraulic friction engagement device is engaged such that the gear stage required for the automatic transmission 14 by the electronic control device (ECT-ECU) 22 is established.

With the SBW-ECU functioning as the control device according to the second embodiment, in S22 corresponding to the drive wheel rotation suppression unit 94, the friction engagement device in the automatic transmission 14 is disengaged to disable power transfer while the reference position learning of the actuator 56 in S23 corresponding to the reference position learning unit 92 is being executed, whereby the rotation of the drive wheels 20 is suppressed. This eliminates the concern that the driving force of the vehicle 10 is unintentionally generated during the reference position learning of the actuator 56.

### Third Embodiment

In a third embodiment, as compared with the first embodiment, there is a difference in that the drive wheel rotation suppression unit 94 stops the rotation of the drive wheels 20 by the brake devices 21 so as to suppress the rotation of the drive wheels 20 while the reference position learning unit 92 is executing the reference position learning of the actuator 56 so as to eliminate unintentional generation of the driving force of the vehicle 10.

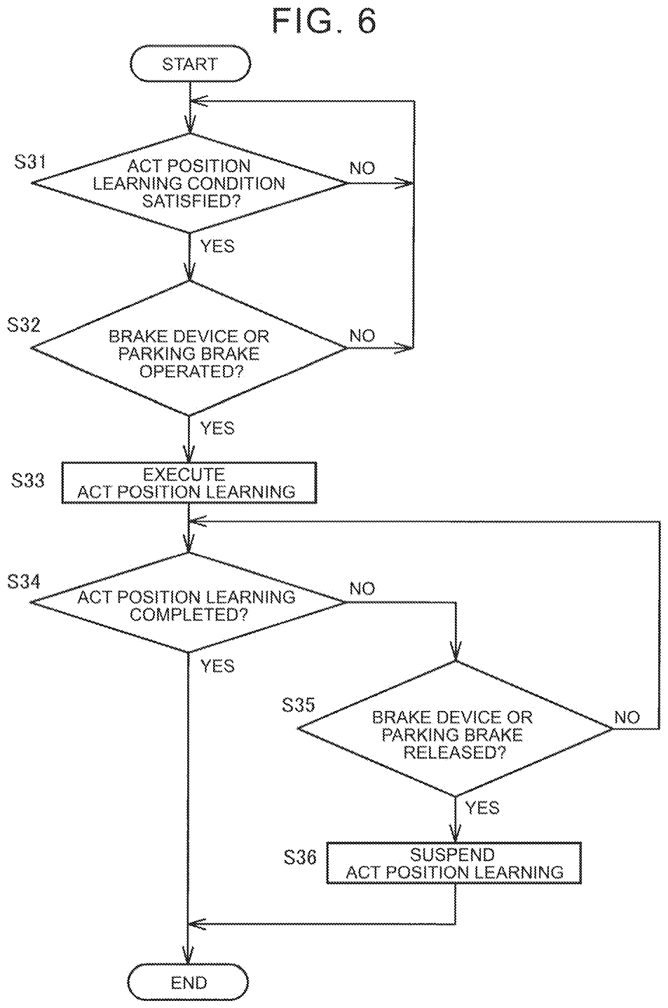

FIG. 6 is a flowchart illustrating a main portion of the control operation of the electronic control device 22 (SBW-ECU) according to the third embodiment. In FIG. 6, in S31, similar to S11, the SBW-ECU determines whether the learning start condition of the P position (ACT position) that is reference position of the actuator 56 is satisfied. When the determination in S31 is negative, the execution of S31 is repeated to stand by.

When the determination in S31 is affirmative, in S32, the SBW-ECU determines whether the brake devices 21 are operated by the drive wheel rotation suppression unit 94 or the parking lock is operated. When the determination in S32 is negative, the execution of S31 and subsequent steps is repeated to stand by. However, when the determination in S32 is affirmative, in S33 corresponding to the reference position learning unit 92, the reference position learning of the actuator 56 is executed.

Next, in S34, similar to S14, the SBW-ECU determines whether the reference position learning of the actuator 56 is completed, that is, whether the reference position (P position) of the actuator 56 is determined. When the determination in S34 is negative, the SBW-ECU determines in S35 whether the operation of the brake devices 21 or the operation of the parking brake is canceled. Normally, the determination in S35 is negative. Therefore, S34 and subsequent steps are executed, and when the determination in S34 is affirmative, this routine is terminated.

However, when the determination in S35 is affirmative, the reference position learning of the actuator 56 is suspended in S36, and this routine is terminated.

As described above, with the SBW-ECU functioning as the control device according to the third embodiment, the brake devices 21 continue blocking of the rotation of the drive wheels 20 in S35 corresponding to the drive wheel rotation suppression unit 94 while the reference position learning of the actuator 56 is being executed in S33 corresponding to the reference position learning unit 92. Therefore, unintentional generation of the driving force of the vehicle 10 is eliminated, which eliminates the concern that the driving force of the vehicle 10 is unintentionally generated during the reference position learning of the actuator 56.

Although the embodiments of the disclosure have been described in detail with reference to the drawings, the embodiments are also applicable to other modes.

For example, in the above-described embodiments, the electronic control device (SBW-ECU) 22 executes the control shown in FIG. 4, FIG. 5, or FIG. 6 in response to the control device of the present disclosure. However, the control in FIG. 4, FIG. 5, or FIG. 6 may be executed by a different electronic control device other than the SBW-ECU, for example, the ECT-ECU or the E/G ECU.

The above description is merely an embodiment, and the disclosure can be implemented in various modified and improved modes based on the knowledge of those skilled in the art.

What is claimed is:

1. A vehicle control device provided with, in a vehicle equipped with an engine and a shift control mechanism that switches a shift position by rotating a detent plate by an electric actuator, a reference position learning unit that executes a learning of a reference position of the actuator that serves as a reference for switching the shift control mechanism by the actuator when a starting condition that is set in advance is satisfied, the vehicle control device comprising a drive wheel rotation suppression unit that suppresses a rotation of a drive wheel of the vehicle while the learning of the reference position is being executed by the reference position learning unit.

2. The vehicle control device according to claim 1, wherein the drive wheel rotation suppression unit prohibits starting of the engine while the learning of the reference position is being executed by the reference position learning unit.

3. The vehicle control device according to claim 1, wherein the vehicle is provided with an automatic transmission between the engine and the drive wheel, and the drive wheel rotation suppression unit disengages a friction engagement device in the automatic transmission to disable power transfer while the learning of the reference position is being executed by the reference position learning unit.

4. The vehicle control device according to claim 1, wherein the vehicle is provided with a brake device that stops the rotation of the drive wheel, and the drive wheel rotation suppression unit blocks the rotation of the drive wheel by the brake device while the learning of the reference position is being executed by the reference position learning unit.
